(19) United States
(12) Patent Application Publication
(10) Pub. No.: US 2025/0095979 A1
(43) Pub. Date: Mar. 20, 2025

(54) ION GUIDE

(71) Applicant: Thermo Fisher Scientific (Bremen) GmbH, Bremen (DE)

(72) Inventor: Hamish Stewart, Bremen (DE)

(73) Assignee: Thermo Fisher Scientific (Bremen) GmbH, Bremen (DE)

(21) Appl. No.: 18/882,521

(22) Filed: Sep. 11, 2024

(30) Foreign Application Priority Data
Sep. 14, 2023 (GB) 2314062.7

(51) Int. Cl. H01J 49/06; G01N 27/622

(52) U.S. Cl. CPC H01J 49/062; G01N 27/622

(57) ABSTRACT

Ions are guided along an ion channel. A plurality of electrodes are arranged on a surface of an ion guide and apply a time-varying potential to repel the ions from the surface. A counter electrode arrangement comprises a main counter electrode portion and has an opening extending along the counter electrode arrangement. The counter electrode arrangement applies a direct current (DC) counter potential to force the ions towards the surface. The time-varying potential and the DC counter potential together confine the ions in the ion guide. The counter electrode arrangement applies a stronger DC counter potential in a region adjacent to the main counter electrode portion than in a region adjacent to the opening, thereby confining the ions in an ion channel corresponding to the opening.

### CROSS REFERENCE TO RELATED APPLICATION

This application claims priority from United Kingdom Application No. 2314062.7, filed Sep. 14, 2023. The entire disclosure of United Kingdom Application No. 2314062.7 is incorporated herein by reference.

### FIELD

The present disclosure concerns an ion guide.

### BACKGROUND

Ion guides are used in various mass spectrometry systems. Ion guides are used to manipulate and control the movement of ions. For example, ion guides are often used to guide ions from an ion source to an analyser.

Certain types of ion guides, such as traveling wave ion guides, use controlled electric fields to separate ions based on their mobility in a gas. This can provide for additional separation and/or characterisation of ions before they reach a mass analyser.

In ion mobility separators that utilise drift separation, ions are forced along a gas-filled ion path by an electric field. This acceleration is resisted by collisions with a buffer gas and ions of differing mobilities reach differing equilibrium velocities and separate, arriving at the end of the path at differing times. The resolving power of this separation process increases with the square root of the length of the ion guide, meaning that high resolution separators typically require very long paths. Linear drift tubes are generally limited to ^{˜}1 m in commercial instruments, whilst achieving longer separations typically requires folding a complex path into a small 2D plane or 3D volume.

A prominent example of a folded path ion mobility separator is SLIM (Structure for Lossless Ion Manipulation) ion guides, of the type described in U.S. Pat. No. 8,835,839B1, U.S. Pat. No. 9,812,311B2, and U.S. Pat. No. 11,209,393B2. These use a sandwiched printed circuit board (PCB) structure with printed arrays of radiofrequency (RF) and direct current (DC) electrodes, forming winding channels with ^{˜}10 m paths that can fit on relatively small surfaces (e.g., within an area of approximately 1 m²). A travelling wave (U.S. Pat. No. 6,894,286B2, U.S. Pat. No. 6,794,641B2) is typically used to propel the ions because maintaining a DC gradient over ^{˜}10 m adds up to a very high terminal potential. Beam switching, as described in US20190103261A1, may be implemented to allow a switchable path that may for example bypass a long mobility separator, which may be advantageous when the device is integrated into a mass spectrometer. This technology is becoming increasingly adopted thanks to high resolving power and simplicity of mechanics and electronics.

A competing ion guide technology arises from adaptation of stacked ring ion guides, whereby a series of apertures forms the ion path (S. Guan and A. G. Marshall, “Stacked-Ring Electrostatic Ion Guide”, J. Am. Soc. Mass Spectrom., 7 (1996) 101-106). U.S. Pat. No. 8,552,366B2 describes the formation of a long helical tube out of many individual electrode plates. The mechanical complexity of having many apertured electrodes induces tighter limits than PCB printing. A single closed loop, such as described in U.S. Pat. No. 9,552,969B2, has been manufactured, but single loops have a major disadvantage, in that ions of greatly differing mobility will lap one another, generating uncertainty as to the number of laps an ion has undergone before being extracted to a detector. This complicates analysis.

The problem of mechanical complexity in constructing helical or spiral ion guides was addressed in U.S. Pat. No. 11,373,850B2, by merging a series of apertures into single plates, reducing the part number of multiturn helices to that of a single cyclic pass.

Another lesser-known ion guide technology is the RF carpet (G. Bollen, Int. J. Mass. Spectrom., 2011, 299, 131-138), whereby the stacked ring ion guide is essentially unfolded over a wide surface, and a plane of repelling RF pseudopotential formed. A counter electrode may be used to pin ions down onto the pseudopotential surface. UK patent application number GB2209555.8 describes the use of RF carpets with additional orthogonal DC or travelling waves used to switch ion beams between two paths.

Other methods for guiding and separation ions exist beyond drift separation. Trapped ion mobility spectrometry as incorporated in the Bruker TIMS-ToF (trapped ion mobility spectrometry time of flight) series of instruments enjoys widespread adoption (Meier, F., Brunner, A. D., Koch, S., Koch, H., Lubeck, M., Krause, M., . . . & Mann, M. (2018); Online parallel accumulation-serial fragmentation (PASEF) with a novel trapped ion mobility mass spectrometer; Molecular & Cellular Proteomics, 17 (12), 2534-2545). An application of this device is to serve as an ion accumulator, releasing mobility (and m/z) concentrated packets of ions to a downstream quadrupole for fine selection and ToF analyser for MS/MS analysis, reducing ion losses on the quadruple by an order of magnitude. Very long drift tubes may also be able to serve in this capacity.

While the above-noted systems perform adequately in many respects, there remains a need to improve the way in which ion guides, particularly ion guides with elongated ion paths, are formed. Therefore, the present disclosure addresses problem associated with constructing ion guides such as ions guides with elongated ion paths.

### SUMMARY

Against this background, the present disclosure provides an ion guide in accordance with claim 1.

The ion guide is suitable for guiding ions along an ion channel and comprises: a plurality of electrodes arranged on a surface of the ion guide and configured to apply a time-varying potential to repel the ions from the surface; and a counter electrode arrangement comprising a main counter electrode portion and having an opening extending along the counter electrode arrangement, the counter electrode arrangement configured to apply a direct current, DC, counter potential to force the ions towards the surface, the time-varying potential and the DC counter potential together confining the ions in the ion guide; and
wherein the counter electrode arrangement is configured to apply a stronger DC counter potential in a region adjacent to the main counter electrode portion than in a region adjacent to the opening, thereby confining the ions in an ion channel corresponding to the opening.

An opening provided in the counter electrode arrangement can provide a weaker counter potential in the region adjacent the opening. This form of potential defines an ion channel in which ions can be confined. This can be used to provide long path lengths. The opening may extend only partially into the main electrode portion (i.e., there may be a trench in a single electrode) or the opening may extend all the way through the main electrode portion, i.e. the opening may be a hole in the counter electrode arrangement (and a secondary electrode portion or backplate may optionally be provided behind the opening).

The ion channel may generally correspond to the opening since the form of the opening dictates the form of the potential in the ion guide. The ion channel may be a region of the ion guide defined by the potential well, e.g., a region in which the potential is less than some percentage of the height of the potential well. The channel potential may be approximately ^{˜}50 mV deep to constrain thermalised ions. In some embodiments, the depth of the potential well may be set to higher voltages, such as up to 0.1V or up to 0.5V to account for space charge effects. The ion channel well depth could be in a wide range of voltages. For example, the ion channel well depth could be from 1% to 90% of the counter electrode (also termed a deflector) potential and still guide ions effectively.

Some embodiments of the present disclosure provide RF carpets (that is, RF pseudopotential surfaces and opposing counter electrode arrangements) with circuitous or winding ion paths generated at least in part by modification of a counter electrode to include an opening, for example, by cutting a focusing line into a counter electrode arrangement. In some embodiments, angling a counter electrode arrangement relative to the RF surface may provide a DC gradient. In some embodiments, travelling wave electrodes are superimposed onto the counter electrode arrangement, which can be used to improve the guiding of ions along an ion channel.

In some embodiments, the ion guide described herein may comprise a counter electrode arrangement that has a first surface at a first distance (in a direction normal to the surface) from the plurality of electrodes and a second surface at a second, greater, distance (in the direction normal to the surface) from the plurality of electrodes, with the second of those surfaces corresponding to the ion channel. The second surface may be a backplate or may be a surface of a trench in the first surface of the counter electrode arrangement.

Embodiments of the present disclosure can provide 2D or 3D ion guides, which can move ions from one surface to another mounted orthogonally (FIG. 10), or on a reverse side (FIG. 11), or on a different level (FIG. 9(a)). This may provide complex 3D ion paths in very small spaces.

Cyclic models are shown in FIGS. 12, 13, 14 and 15. These can be constructed either as assemblies of substantially planar surfaces or as a curved RF carpet. Such arrangements can provide advantages such as a long ion path length, particularly if 3D spiral motion is induced by the shape of the counter electrode.

Embodiments of the present disclosure seek to provide ion guides with simple mechanics, long path lengths, high mobility resolution, and/or high ion capacity. In some cases, the ion guide may comprise only one surface of trapping RF electrodes such that only one surface of the ion guide is likely to be contaminated by ion deposition. Further advantages arise from being able to generate DC gradients from angling the counter electrode.

These and other advantages will become apparent from the following disclosure.

### LISTING OF FIGURES

The present disclosure will now be described by way of example, with reference to the accompanying figures, in which:

FIGS. 1(a) and 1(b) show an ion guide in an embodiment of the disclosure;

FIG. 2 shows an ion guide in an embodiment of the disclosure;

FIGS. 3(a) and 3(b) show embodiments of openings in counter electrode arrangements;

FIG. 4 shows a mass spectrometry system incorporating an embodiment of the disclosure;

FIGS. 5(a) and 5(b) show an ion guide in an embodiment of the disclosure;

FIGS. 6(a) and 6(b) show an ion guide in an embodiment of the disclosure;

FIGS. 7(a) and 7(b) show an ion guide in an embodiment of the disclosure;

FIGS. 8(a) and 8(b) show an ion guide in an embodiment of the disclosure;

FIGS. 9(a) and 9(b) show ion guides in embodiments of the disclosure;

FIG. 10 shows an ion guide in an embodiment of the disclosure;

FIG. 11 shows an ion guide in an embodiment of the disclosure;

FIG. 12 shows simulated behaviour of an ion guide in an embodiment of the disclosure;

FIG. 13 shows simulated behaviour of an ion guide in an embodiment of the disclosure;

FIGS. 14(a), 14(b) and 14(c) show an ion guide in an embodiment of the disclosure;

FIG. 15 shows an ion guide in an embodiment of the disclosure; and

FIGS. 16(a) and 16(b) show an ion guide in an embodiment of the disclosure.

### DETAILED DESCRIPTION

The present disclosure provides improved ion guides and addresses problems associated with constructing ion guides. Elongated ion paths may be useful for ion mobility separation but can be used in many other contexts. In some cases, it may be desirable to construct an ion channel that provides a long ion path in a relatively small area. For example, some embodiments provide ion channels that fold a path of several metres into a small area (e.g., roughly 0.5×0.5 m), have low ion losses, have high space charge capacity (internal volume), and/or are able to resist negative influences due to charging and contamination.

This disclosure provides devices that incorporate time-varying oscillatory potentials and opposing counter potentials. For instance, an RF carpet may be provided by a pseudopotential surface created by an array of electrodes arranged on a surface, with ions pinned to the RF carpet by an opposing DC counter electrode (otherwise described as a deflector herein). In some embodiments, a travelling wave (also described herein as a T-wave) is used to guide ions along an ion channel, either superimposed onto some or all of the RF electrodes, or applied to a separate array of electrodes mounted on the deflector to propel the ions along the ion channel.

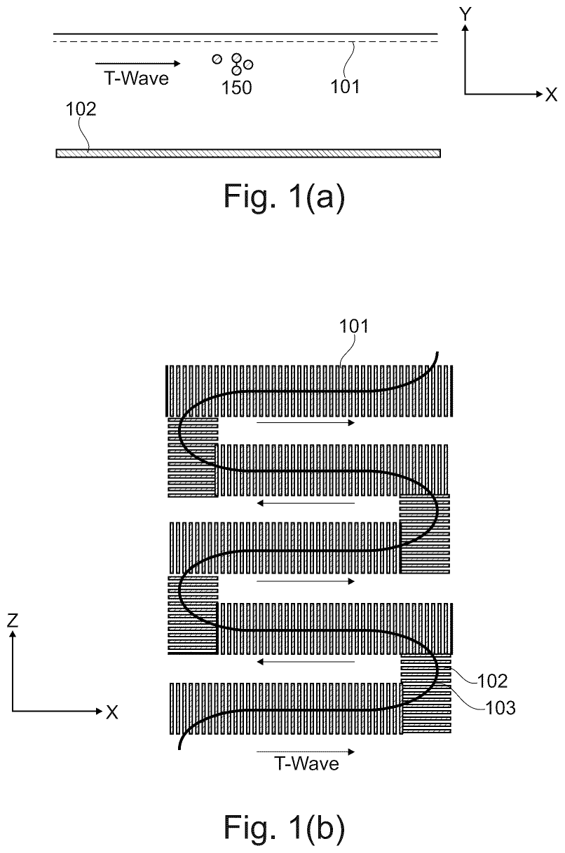

Such an arrangement is shown in FIG. 1(a). FIG. 1(a) depicts an ion guide having a plurality of electrodes 101, which essentially provide an RF surface, arranged on a surface (which is shown as being flat, but which need not be flat) of the ion guide, the plurality of electrodes configured to apply a time-varying potential to repel ions 150 from the surface. The time-varying potential may provide a pseudopotential barrier. The pseudopotential barrier will have a form corresponding to the plurality of electrodes 101, and so may be substantially planar. A counter electrode arrangement 102 (which in this embodiment is shown as a single counter electrode) is configured to apply a direct current (DC) counter potential to force the ions 150 towards the surface; this DC counter potential effectively repels the ions from the counter electrode arrangement and pins the ions against the time-varying potential, so that the time-varying potential and the DC counter potential together confine the ions 150 in the ion guide.

FIG. 1(b) shows how an ion channel can be achieved by providing an RF carpet 101 and a guide rail or opening 103 in the deflector 102 that helps to confine ions in an ion channel.

The counter electrode arrangement 102 is configured to apply a stronger DC counter potential in a region of the ion guide adjacent to the main portion of the counter electrode than in a region of the ion guide adjacent to the opening extending along the counter electrode arrangement 102. This is shown in FIG. 1(b) by the circuitous trace 103, which provides a weakened DC potential region of the counter electrode arrangement 102. This confines the ions 150 in an ion channel corresponding to the opening in the counter electrode arrangement. The ion channel is elongate (i.e., it is much longer (in a direction in which ions travel) than it is wide (in a direction orthogonal to the direction in which ions travel), by at least one order of magnitude or by a factor of 10). In FIG. 1(b), the opening in the counter electrode arrangement 102 defines an ion channel that folds back on itself four times, but different numbers of folds (e.g., 1, 2, 3, 4, 5, 6, 7) can be provided. The ion channel and the opening do not necessarily need to fold back on themselves fully; they could follow a generally circuitous or meandering route that does not fully turn back. In general, the ion channel and the opening may take any suitable form, such as being linear and/or curved, etc.

The ion guide shown in FIGS. 1(a) and 1(b) comprises a plurality of electrodes 101 that span the x-z plane but which are relatively thin (e.g. substantially planar) in the y-direction. Similarly, the counter electrode arrangement 102 extends in the x-direction and in the z-direction but is relatively thin in the y-direction. An ion channel is defined by the opening in the counter electrode arrangement 102 and the ions 150 that move along the ion channel are substantially constrained in the y-direction while the channel extends in the z- and/or x-directions and causes ions to move in the z- and/or x-directions as the ions move along the ion channel. The directions x, y and z are mutually orthogonal directions.

To achieve long path lengths in an ion guide, a large RF surface area may be carved up into a winding channel, and ions entrained within that ion channel and prevented from taking a direct route through the ion guide. In SLIM devices, printed DC electrode arrays are used to prevent ions escaping the defined path. Embodiments of the present disclosure instead use the counter electrode arrangement to assist with ion confinement. The counter electrode arrangement may comprise a flat metal plate, which may be altered so that a weakened DC potential region defining the ion channel may be traced into the plate. Since the counter electrode repels the ions, the weakened region acts as a relatively attractive rail, locking the ions to it. The weakened region may be formed by, for example, etching a relatively deep trench into a relatively thick deflector, or providing a hole in a relatively thin deflector and allowing field penetration from a less repulsive backplate.

FIG. 1(b) shows how such an opening (shown as a rail) may be combined with an RF surface 101 with superimposed travelling waves running in alternating directions to produce a complex folded ion path. The curvature of the opening ensures that the opening minimally conflicts with the travelling waves applied in the ion guide.

The counter electrode arrangement may be a single unitary electrode with a main portion and an opening therein, or the counter electrode arrangement may comprise multiple electrode portions either side of a hole extending all the way through the counter electrode arrangement.

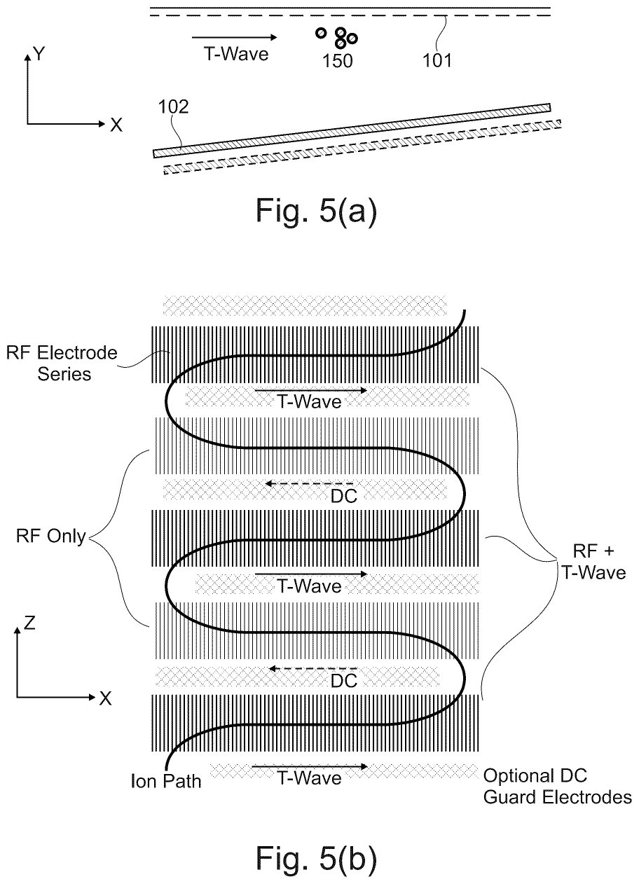

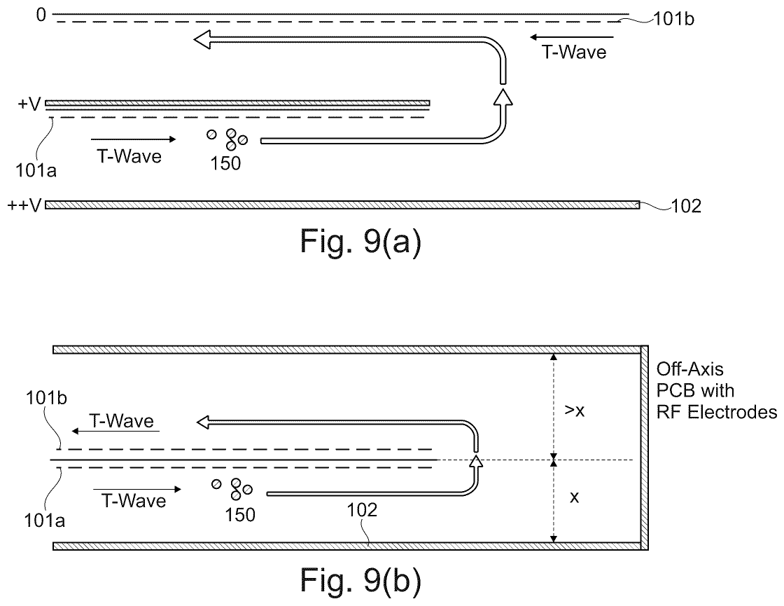

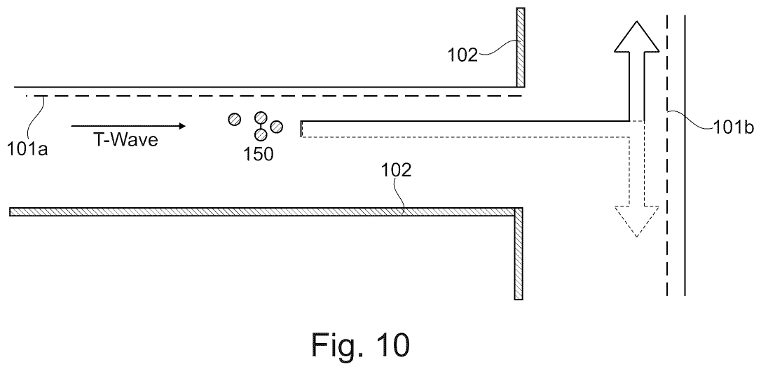

A number of advantageous features are shown in FIGS. 1(a) and 1(b). In general terms, it may be advantageous for the opening and the ion channel to be circuitous. Circuitous ion channels are also shown in FIGS. 5(a) to 16(b). This can ensure that long ion paths are attained, which can be particularly useful in ion mobility separation. The opening and the ion channel may equivalently be described as winding or meandering. The opening and the ion channel may be circuitous in two spatial dimensions (as shown in FIGS. 1(a) and 1(b)) or in three spatial dimensions (as discussed with reference to FIGS. 9(a) to 16(b)).

The ion guide, the opening and the ion channel may extend (e.g., generally extend between an ion inlet and an ion outlet) in a first direction (from the bottom left to the top right of FIG. 1(b)) and the opening and the ion channel may each comprise one or more portions extending away from the first direction. The ion channel may include a plurality of regions that deviate away from a straight line between an ion inlet and an ion outlet. This may be described as the opening and the ion channel each comprising one or more first portions that extend in the first direction and one or more second portions that extend in a second direction that is different to the first direction. In some embodiments, the opening and the ion channel may further comprise one or more third portions extending in a third direction that is different to the first and second directions. When described in such terms, the second and third directions may be opposite directions (as shown in FIG. 1(b), where the opening and ion channel turn through 180 degrees multiple times) and/or an angle between the second and third directions may be greater than 90 degrees or greater than 120 degrees. The first direction may be perpendicular to the second direction and/or the third direction.

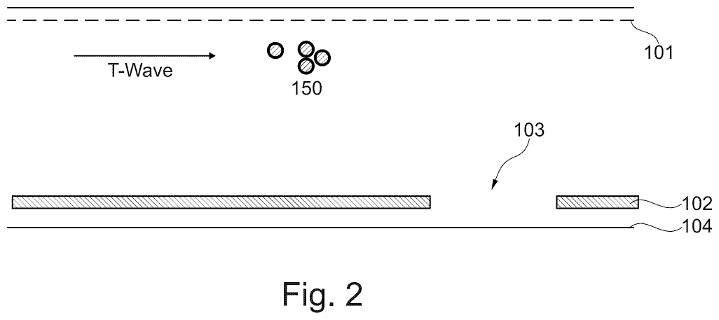

FIG. 2 shows an example of how a relatively attractive channel 103 (provided as an opening in a counter electrode arrangement) may be cut into a deflector electrode 102, with field penetration from a backplate 104 helping to provide ion confinement. The deflector 102 and the backplate 104 together define a counter electrode arrangement. The combined effect of the gap in the deflector 102 and the backplate 104 provides an attractive weakened region that corresponds to the opening in the deflector and hence defines an ion channel. The main electrode portion of the counter electrode arrangement 102 is adjacent to the ion channel, while the backplate 104 is behind the main electrode portion of the counter electrode arrangement 102.

For a large 1/4 m² plane for a relatively long flight path, a thin (e.g. ^{˜}0.5 mm thick) deflector 102 plate may be supported by additional material, unless there are many mounting points to the RF electrode surface 101. In some cases, both the deflector 102 and the backplate 104 may be mounted to a frame, which may be common to both components. The frame might also be or form the backplate 104. In any event, an attractive region may be created and hence an ion channel may be defined by an opening in the deflector 102 and field penetration from the backplate 104.

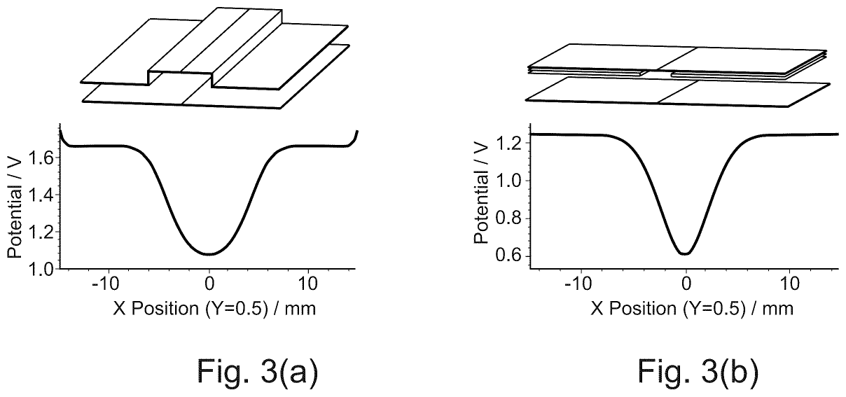

FIGS. 3(a) and 3(b) show field simulations illustrating the attractive potential well provided by embodiments of the present disclosure. FIG. 3(a) shows a trench cut into a thick deflector electrode and FIG. 3(b) shows a hole cut into a deflector with a weaker DC potential backplate. The field simulations in FIGS. 3(a) and 3(b) were constructed in the MASIM3D program, and show a >0.5V attractive potential well generated by scoring a 5 mm wide hole in a 0.5 mm thin deflector plate at 10V, or a 2 mm deep, 10 mm wide trench in a thick plate. The gaps between the counter electrode arrangement and the RF electrode surface were 4 mm and 3 mm respectively, and the measurement taken at 0.5 mm from the RF surface electrodes where ions would be likely to sit. The action of the deflector was not compromised by the trenches provided.

For ion mobility measurements, higher pressures improve resolution, up to the limit of RF trapping functionality (around 0.1-10 mbar, or preferably 1 mbar). The RF surface may be PCB printed for simplicity, although it is possible to construct RF carpets from very complex assemblies of long plates, or small electrodes mounted to a substrate. RF electrode arrays can serve as highly tolerant ion trapping mechanisms. Alternating RF phases may be applied to each electrode in an array of electrodes on a surface (e.g., a substrate) of the RF carpet. Electrode thicknesses and separations of 0.5 to 1.5 mm are typical for such devices, with applied RF of 20-2000V at frequencies of 1-3 MHz. A travelling wave (T-Wave) may be superimposed upon the RF electrodes, or on another array of electrodes as desired. This may be implemented as a 4+ phase additional RF, with each phase 90 degrees out and running typically at lower voltage and frequency than the trapping waveform. For example, a 5-50V travelling wave with frequency of 50-250 KHz may be provided. Travelling waves may also be implemented as a series of transient DC pulses, giving the impression of a DC pulse moving down the electrode series, often 1 or 2 electrodes up and 3-6 electrodes down at a time.

The simulations in FIGS. 3(a) and 3(b) show the effect of an opening in a counter electrode arrangement. The potential varies in the x-direction with a potential well (and hence an ion channel) forming adjacent to the opening in the counter electrode arrangement. The region of the ion guide adjacent to the main counter electrode portion may be defined as the region that is closer to the main counter electrode portion than to the opening in the counter electrode arrangement. Similarly, the region of the ion guide adjacent to the opening may be defined as the region that is closer to the opening than to the main counter electrode portion. Therefore, these regions may be distinguished by a surface that extends from the edge of the opening in the counter electrode arrangement in a direction normal to the surface of the counter electrode arrangement; all points on one side of this surface will be closer to the opening than to the main counter electrode portion and this set of points may be termed a region of the ion guide that is adjacent to the opening. As the potentials formed are not perfect square wells and have curved shapes, as shown in FIGS. 3(a) and 3(b), the ion channels formed by the electrode arrangements in the present disclosure do not perfectly correspond with the shape of the opening, but do generally correspond with the shape of the opening in the counter electrode arrangement.

In generalised terms, the counter electrode arrangements described herein may be deflector electrodes. An opening in the counter electrode arrangements may be an elongate opening in the counter electrode arrangement. For example, the openings described herein may be an order of magnitude longer (in a direction in which ions travel) than they are wide (i.e., a length of the opening is at least 10 times its width), or two orders of magnitude longer than they are wide (i.e., a length of the opening is at least 100 times its width).

In some embodiments, the counter electrode arrangement described herein may comprise a counter electrode and the opening may comprise a recess (e.g., a small space created by providing a surface further back, in a direction normal to the surface on which the plurality of electrodes is arranged, from the rest of the counter electrode) in the counter electrode. For example, the counter electrode arrangement may be a unitary (one piece of metal) counter electrode with a trench or groove serving as the opening. In such cases, a surface of the main counter electrode portion (i.e. the portion of the counter electrode arrangement that is closest to the plurality of electrodes arranged on a surface) may be at a first distance (e.g., in a direction normal to the surface on which the plurality of electrodes is arranged) from the plurality of electrodes and a surface of the opening (e.g., the surface of the interior of the recess, trench or groove) may be at a second distance from the plurality of electrodes, the second distance being greater than the first distance. Hence, the opening may extend at least partially through the counter electrode arrangement. The counter electrode arrangement may be arranged generally on a surface, where the counter electrode arrangement surface is substantially parallel to the surface on which the plurality of electrodes is arranged. When the counter electrode is flat (i.e. when the counter electrode arrangement surface is generally planar), this may provide a carpet-like structure; however, in some embodiments, the counter electrode arrangement surface and the surface on which the plurality of electrodes is arranged may be curved and parallel to one another.

In some embodiments, the opening may extend fully through the counter electrode arrangement. That is, the opening may be a hole in the counter electrode arrangement. In such cases, the counter electrode arrangement may comprise a backplate (a second surface of the counter electrode arrangement) behind the opening (i.e., the main counter electrode portion is between the backplate and the ion channel (and is between the backplate and the opposing plurality of electrodes), where the backplate is configured to apply a weaker DC counter potential than the main counter electrode portion (or even a small attractive potential). Thus, a potential well of the type shown in FIGS. 3(a) and 3(b) can be provided. That is, in the ion guides described herein, the counter electrode arrangement may be configured to apply a DC potential having a potential minimum corresponding to the opening and to the ion channel; the form of the ion channel may be defined by the shape of the opening.

The counter electrode arrangements described herein may comprise one or more main counter electrode portions adjacent to the opening and/or on each side of the opening. For example, the counter electrode arrangement may comprise two main counter electrode portions with the opening dividing the counter electrode arrangement. The main counter electrode portion(s) may be planar surface(s).

In some embodiments, an ion mobility separator using an ion guide as described herein may be coupled to a mass spectrometer, such as a tandem mass spectrometer. The disclosure therefore provides a mass spectrometry system comprising a mass analyser and any one (or more) of the ion guides described herein. The ion guide may be configured to provide ions to the mass analyser (directly or indirectly via intermediate components).

An ion mobility spectrometer may also be provided. An ion mobility spectrometer may include any of the ion guides described herein, which can provide a long ion path over which ions can separate according to their mobility (hence providing high resolution ion mobility data).

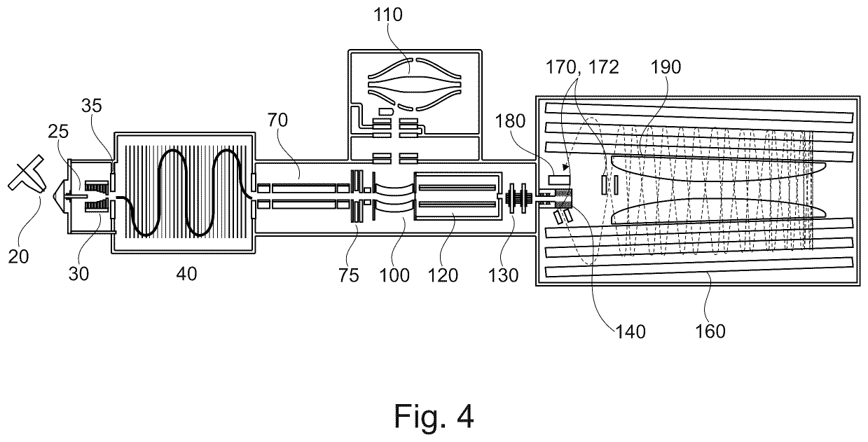

In some embodiments, the ion guide can be used to add one or both of ion mobility information to the mass analysis and/or to work in a conjoined fashion with the quadrupole (or other mass filter) to limit the proportion of ions becoming deposited on the quadrupole rods. FIG. 4 shows an example of a hybrid Orbitrap™/multi-reflection time-of-flight mass spectrometer, as described in U.S. Pat. No. 10,699,888B2, modified to incorporate an ion mobility separator based upon embodiments of the present disclosure.

A number of elements of FIG. 4 are configured similarly to the systems described in U.S. Pat. No. 10,699,888B2 and illustrated in FIG. 1 thereof. Therefore, U.S. Pat. No. 10,699,888B2 is incorporated herein by reference and the same reference numerals are used for elements common to U.S. Pat. No. 10,699,888B2 and the present disclosure. In particular, the functioning of each of the following elements is described more fully in U.S. Pat. No. 10,699,888B2: electrospray ionisation source 20; capillary 25; quadrupole mass filter 70; C-trap 100; orbital trapping mass analyser 110; fragmentation chamber 120; multipole ion guide 130; extraction trap 140; opposing tilted ion mirrors 160; deflectors 170, 172; detector 180; and correcting stripe electrode 190. FIG. 4 additionally includes an ion funnel 30 that receives ions from the capillary 25 and an optional calibrant source 35 that provides calibrant. The ions pass into an ion mobility separator 40 that incorporates an ion guide according to the present disclosure. An optional charge detector 75 is provided to detect charged particles.

In use, ions are generated from a sample by the electrospray ion source 20 and enter the vacuum system through the capillary 25, to be captured within the ion funnel 30. In this case, the funnel 30 may act as an accumulating device for pulsed introduction to the separator 40, but such functionality may also be incorporated into the separator 40 itself with a gate electrode. Ions are then introduced to the separator 40 and make their way through the winding path, becoming separated by mobility (and substantially by m/z and charge state). As ions of different mobility emerge to the quadrupole 70, the quadrupole 70 is set to transmit ions only at a target ion m/z within that mobility window, based on an understanding of the analyte type and the relationship between mobility and m/z. Selected ions are then optionally fragmented and sent to the orbital trapping analyser 110 or the multi-reflection-time-of-flight analyser for mass analysis.

A bypass to the separator 40 is not shown in FIG. 4, but could be provided so that wide m/z range mass spectra could be recorded without the time and ion loss of the separator device 40. This could be provided as a second path built into the RF carpet PCB, or by an additional ion guide with access controlled by beam switching technology, e.g. as described in US20190103261A1, which is incorporated herein by reference. As an alternative, in some embodiments the orthogonal directing force (i.e., the alternating T-Waves in FIGS. 1(a) and 1(b)) may be disabled and ions may be pushed straight to the ion outlet in a more direct path, rather than the circuitous paths shown. This approach however could not be performed in parallel with the accumulation and separation, which a parallel shorter path could perform. The beam switch and the parallel path might also start before the accumulation region for this reason, and then full MS spectra could be acquired repeatedly during a single separation cycle.

FIGS. 5(a) and 5(b) show an embodiment in which the deflector 102 (counter electrode arrangement) is tilted with respect to the surface of the RF electrodes 101 to provide a DC gradient in the Z and X directions, whilst a travelling wave superimposed on alternating sets of the RF electrodes 101 pushes the ions 150 in opposition to the DC gradient in the X direction. In this way, the T-Wave acts to lift the potential of the ions 150, resetting them so that they may then drift back when they enter a DC-only region of the ion guide. Optionally, the segments of the RF electrodes 101 may be separated by DC guard electrodes, which may extend up from the RF surface 101, descend from the deflector electrode 102, or connect the two and provide mechanical support. While not shown in FIGS. 5(a) and 5(b), an optional opening (e.g., a trench or a hole as described previously) may be provided in the counter electrode arrangement 102 to aid the confinement of the ions 150.

Returning to the general terms used previously, in some embodiments, the time-varying potential applied by the plurality of electrodes is a radiofrequency, RF, oscillatory potential. This may provide an RF carpet type structure. Accordingly, each electrode of the plurality of electrodes may be configured to apply a potential with a different phase (e.g., an opposite phase) to each adjacent electrode of the plurality of electrodes.

The plurality of electrodes may comprise a set of electrodes configured to apply a travelling wave potential along one or more portions of the ion channel to guide the ions along the ion channel. These portions could extend in any spatial direction. The plurality of electrodes may additionally or alternatively comprise a set of electrodes configured to apply a DC potential gradient along one or more portions of the ion channel to guide the ions along the ion channel. The DC potential gradient could be superimposed on RF electrodes, in some cases. In some embodiments, a plurality of different sets of electrodes may be configured to apply alternating travelling wave potentials and DC potential gradients along respective portions of the ion channel to guide the ions along the ion channel. Such an arrangement might be as shown in FIGS. 5(a) and 5(b), which may optionally be combined with an opening in the counter electrode arrangement (deflector).

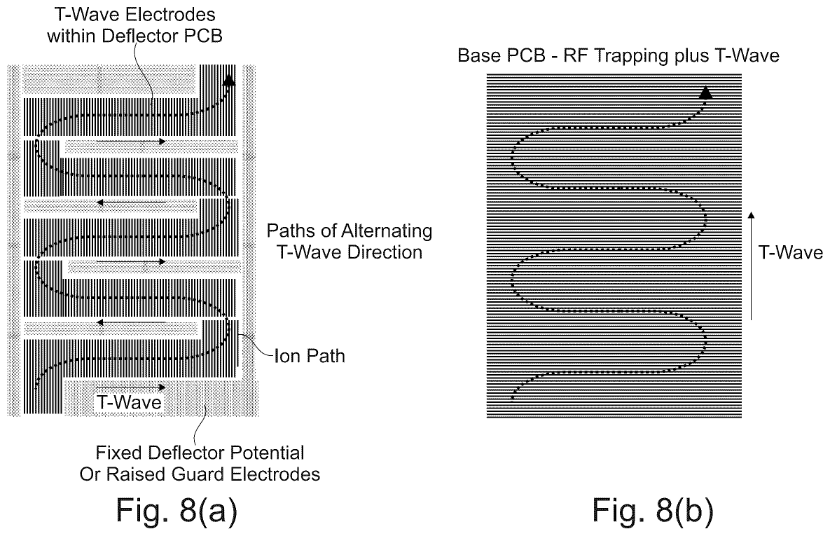

The plurality of electrodes may be disposed along the length of the ion channel; that is, the majority of (e.g., at least 90% of the length of) the channel may be directly adjacent to an electrode that applies a time-varying potential. The electrodes may follow the meandering path of the channel, as shown in FIGS. 7(a), 7(b), 8(a) and 8(b), for example. The electrodes of the plurality of electrodes may be substantially perpendicular to the ion channel, at least for a portion of the length of the ion channel. For instance, the channel in FIG. 5 is substantially perpendicular to the plurality of electrodes for most of the length of ion channel, with only small gaps (in the z-direction) between the parallel rows of electrodes.

The counter electrode arrangement may be inclined (i.e., at a non-zero angle) with respect to the surface on which the plurality of electrodes is arranged. For example, by varying the distance between the counter electrode arrangement and the plurality of electrodes, it may be possible to provide a DC gradient to guide the ions along at least a portion of the ion channel. The inclination may be opposite to the direction in which the plurality of electrodes drives the ions. For example, as shown in FIGS. 5(a) and 5(b), travelling waves may drive the ions in the positive X-direction while the general inclination of the counter electrode arrangement may drive ions in the negative X-direction. This pattern alternates as the ions move along the ion channel. The counter electrode arrangement is configured to apply a travelling wave potential along one or more portions of the ion channel to guide the ions along the ion channel.

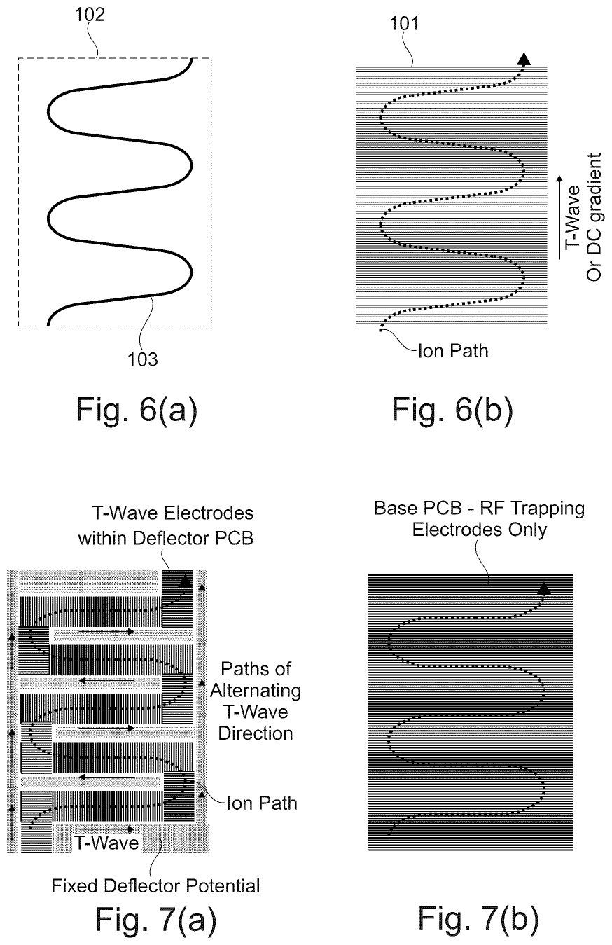

FIGS. 6(a) and 6(b) show a further embodiment of an ion guide. In this embodiment, an attractive trace 103 (e.g., a trench or hole) in the deflector electrode 102 (which could alternatively be on a PCB) provides a winding or circuitous route, and a single direction of T-Wave and/or a DC gradient superimposed on the RF surface electrodes 101 (which may be on a PCB base) drives ions from the ion inlet to the ion outlet. In this embodiment, the route of the opening does not fully turn backwards, i.e., the DC does not run completely against the travelling wave, which prevents the ions becoming completely trapped.

A travelling wave may be supplied from an array of electrodes printed on the deflector 102 itself or printed on a backplate PCB with a matching trench or hole cut into the deflector plate 102.

FIGS. 7(a) and 7(b) shows an embodiment where the route travelled by the ions and the travelling wave are defined by the deflector side, whereas the RF electrodes are solely responsible for generating an RF surface. In FIG. 7(a), T-Wave electrodes printed upon a deflector PCB create an ion path with an RF-only surface for the RF carpet. The T-Wave need not be 90 degree angled, but may follow a curved path instead.

In FIGS. 8(a) and 8(b), one direction of travelling wave is generated from these electrodes instead. FIGS. 8(a) and 8(b) shows an alternative scheme to FIGS. 7(a) and 7(b), in which T-Waves are applied to the deflector electrode arrangement for one dimension of motion, and to the RF carpet array for the other dimension. An advantage of FIGS. 7(a), 7(b), 8(a) and 8(b) is that the RF surface electrodes are of limited complexity, opening up the possibility that they may be formed from solid electrodes rather than printed.

It will be appreciated that multiple combinations of DC gradients, time-varying potentials, travelling waves and formed channels can be provided and various combinations of the techniques described in FIGS. 1(a) to 8(b) can be used.

In the above-described embodiments, ion motion has been on a single flat plane. However, the techniques described above can be extended into three dimensions. More complex folded paths may be provided so that ions may benefit from three-dimensional motion, which for PCB-based ion guides may involve ions being transferred between different surfaces. In some embodiments, curved PCBs may be provided (including with printed electrodes).

FIG. 9(a) shows an embodiment in which a travelling wave drives ions 150 off the end of an RF surface 101a, before the ions fall under the influence of the DC field of the deflector 102 onto another RF surface 101b. As shown in FIG. 9(a), the second RF surface 101b may be spaced apart from and parallel to the first RF surface 101a. Alternatively, the second surface 101b may be positioned back-to-back with the first surface 101a, as shown in FIG. 9(b), and a second deflector 102 mounted below, or the back face of the first surface substrate may serve as a deflector for a second RF surface mounted below. In the former case, the same deflector potential may be used, though it may help somewhat to have the second surface be further from its deflector than the first (i.e., the deflectors may be at distances of x and a second distance that is greater than x, as shown in FIG. 9(b)), to generate a net DC shift down to the second surface 101b from the first surface 101a. In the case of the latter, the travelling wave may continue around the edge of the substrate/PCB so that the RF surface effectively follows a sharp bend.

The end of a PCB may easily be metallised, so a single electrode may be readily formed. The back-to-back arrangement in FIG. 9(b) may experience undesirable effects due to the unterminated RF at the edge of the PCB. There may also be an RF barrier created by this sudden ending of the RF carpet, which the T-Wave would preferably be strong enough to overcome. Optionally, the end of the PCB may have only DC applied to reduce this fringe field and any resultant RF heating.

Returning to the general terms used previously, the ion guides described herein may provide ion paths that are circuitous in three dimensions. In some embodiments, the counter electrode arrangement may at least partially or fully enclose the plurality of electrodes (or pluralities of electrodes, if multiple sets are present). For example, the counter electrode arrangement may extend in a first direction and ions may orbit around an RF carpet (or RF carpets) that extends in the first direction. To assist with this, an opening in the counter electrode arrangement may extend along one or more (i.e., one or a plurality of) internal surfaces of the counter electrode arrangement. This may define a potential well that follows a cyclic or helical path with an axis extending in the first direction.

The surface or surfaces on which the plurality of electrodes is or are arranged may be substantially planar. They may be back-to-back planes as shown in FIG. 9(b) or the planes may be spaced apart, as shown in FIG. 9(a). Hence, in general terms, the ion guides described herein may comprise a second plurality of electrodes (e.g., a second RF carpet) arranged on a second surface of the ion guide, the second plurality of electrodes configured to apply a second time-varying potential to repel the ions from the second surface. The first plurality of electrodes and the second plurality of electrodes may face in the same direction, in different directions, or in opposite directions. For instance, the second plurality of electrodes may be arranged on a rear surface of the surface on which the first plurality of electrodes is arranged. That is, the first and second pluralities of electrodes may be arranged back-to-back, as shown in FIG. 9(b). The first surface and the second surface may be parallel and/or planar.

In some embodiments, there may be a third plurality of electrodes arranged on a third surface. For example, the parallel arrangement in FIGS. 9(a) and 9(b) could be combined with an orthogonal or angled third surface, as shown in FIG. 10.

A combination of electrodes and counter electrodes can provide complex three-dimensional paths. For instance, in some embodiments of the present disclosure, the ion channel may be any one or more of: cyclic; helical; and/or circuitous in two or three dimensions.

FIG. 10 shows the transfer of ions 150 from an ion channel adjacent to a first surface 101a, to a second, orthogonal surface 101b. Once the ions 150 have landed on the orthogonal surface 101b, the ions 150 may be moved in either direction (up or down in FIG. 10) by a DC gradient and/or T-Wave applied to the electrodes on the second surface 101b.

Hence, in general terms, in such an embodiment the second surface may be inclined (i.e., at a non-zero angle) with respect to the first surface or perpendicular to the first surface. Ions may be transferred from one surface to another surface through appropriate application of potentials and potential gradients.

The second plurality of electrodes may be configured to apply a travelling wave potential(s) and/or a DC potential gradient potential(s) along one or more portions of the ion channel to guide the ions along the ion channel. This may operate similarly to the embodiments described previously, with alternating portions of the ion channel being defined by different potentials applied to different electrodes or sets of electrodes. Preferably, the ion channel extends from the first plurality of electrodes to the second plurality of electrodes. That is, ions can travel along an ion channel adjacent to a first surface, and then appropriate potentials can be applied at the region between the first and second surfaces, so as to transfer ions from being pinned to the first surface to being pinned to the second surface. The ions can be pinned against the second surface through the combination of the time-varying potential applied by the second surface and a DC counter potential applied by any potentials applied to electrode(s) of the counter electrode arrangement. For instance, in some embodiments, the counter electrode arrangement may comprise a second counter electrode arrangement opposing the second plurality of electrodes. To ensure a continuous ion path is defined, the opening may extend along the first counter electrode arrangement and along the second counter electrode arrangement.

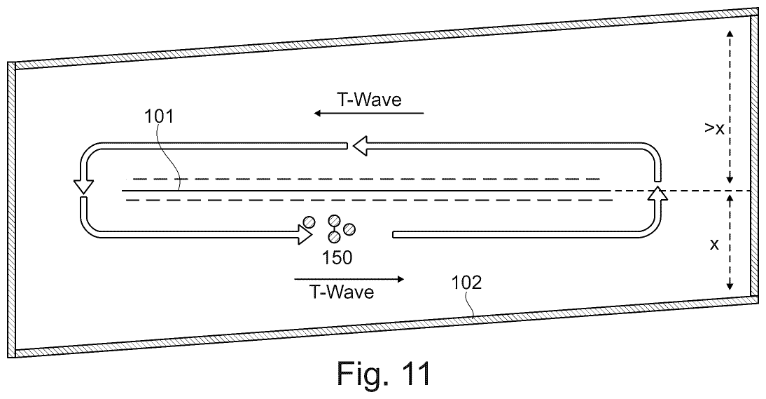

FIG. 11 shows an extension of the embodiment of FIGS. 9(a) and 9(b) to form a cyclic ion path. A cyclic ion guide is provided with back-to-back PCB electrodes 101 within a box defined by the deflector 102 (counter electrode arrangement). The deflector 102 is shown in FIG. 11 as being angled (i.e., having a parallelogram cross-section) which may help push the ions 150 around the sides of the RF electrodes 101. Of course, deflectors having other cross-sections (e.g., square or rectangular) could be used as long as appropriate potentials are applied within the ion guide. In any case, the counter electrode arrangement may at least partially enclose or fully enclose the first plurality of electrodes and/or the second plurality of electrodes. Thus, a long three-dimensional ion channel may be defined.

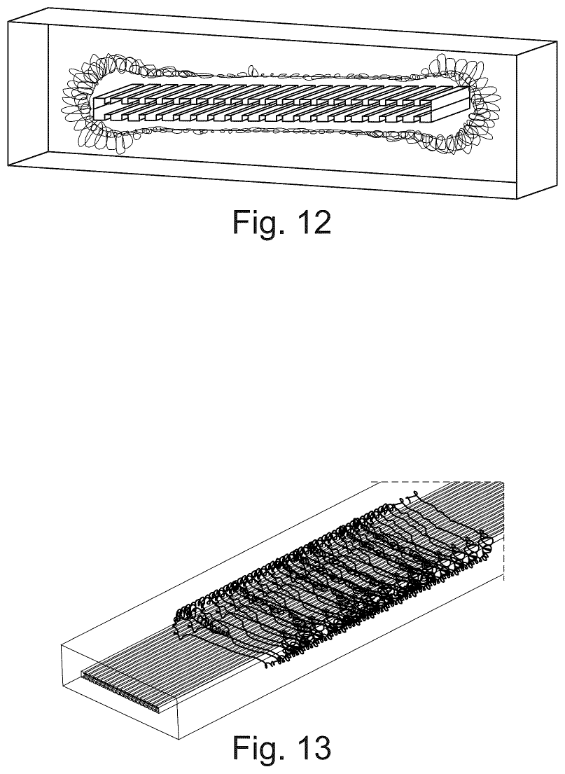

FIG. 12 shows a MASIM3D simulation of ion motion in a system of the type shown in FIG. 11. In FIG. 12, the RF electrodes were 0.4 mm thick, with a 100V 2 MHz trapping RF applied. The repeller DC was set to 10V, and the travelling wave was a 4-phase 200 KHz RF of 7.5V amplitude. It may be seen that ion motion is greatly perturbed by the fringe RF at the point of 180-degree rotation, and it is expected that the inverse scheme with only 90-degree rotation at each corner would be preferable. In any case, this simulation demonstrates that such mechanisms can be used to provide long ion paths.

An advantage of such embodiments is that this design may easily be extruded in the Z-direction to form a 3-dimensional ion channel within the ion guide. FIG. 13 shows how the device of FIG. 12 can be extended with a small DC gradient superimposed, to drive ions down the length of the system. The ion motion forms a spiral, but without constraint in this drift dimension the trajectories spread out widely and overlap. Therefore, a constraint mechanism may be provided; for example, such embodiments may benefit from having a spiral opening (e.g., a recess or a full opening) in the counter electrode arrangement to improve the definition of the ion channel, as discussed previously.

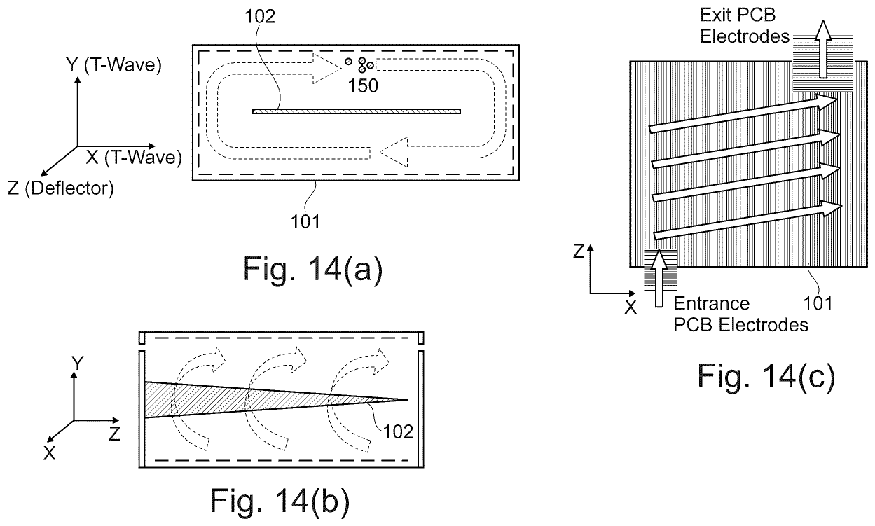

The inverse of the structure of FIGS. 11 to 13 is shown in FIGS. 14(a), 14(b) and 14(c). FIG. 14(a) shows a cyclic ion guide with an assembly of PCB electrodes 101 surrounding a central deflector 102, FIG. 14(b) shows an out-of-plane DC gradient supplied by a wedged deflector 102, and FIG. 14(c) shows ion motion in 3D extruded version of the ion guide, showing an elongated coiled ion path. Here, the PCB printed electrodes 101 are mounted on the inside of an outer layer and the deflector 102 is positioned in the centre. This may be provided with an arrangement of flat PCBs to form the RF electrodes 101.

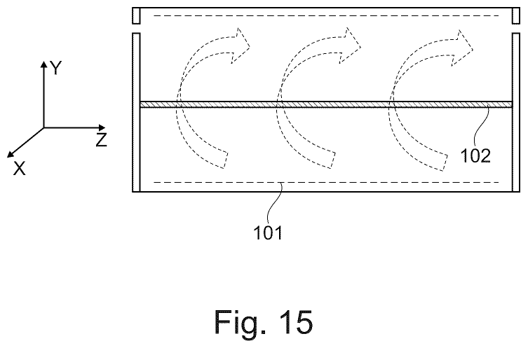

FIG. 14(b) shows how ions may be induced to spiral up the length of the guide by a wedge or square pyramid shape in the deflector 102, though the deflector 102 may also be a PCB with printed electrodes with their own DC gradient of T-Wave generated, as shown in FIG. 15 (in which case an opening may or may not be provided in the deflector 102).

FIGS. 14(a), 14(b) and 14(c) do not show that the printed RF electrodes 101 may have gaps to mount DC guard electrodes that follow the spiral path for drift control, and to provide mechanical support for the deflector 102. The deflector 102 may also have an etched guidance path (i.e., an opening in the counter electrode arrangement) as described with reference to FIGS. 1(a) and 1(b). The front and back of the device is accessible, allowing injection and extraction guides which may be integrated into the PCB. Here, the deflector 102 is conical and incorporates spiral grooves (openings) to constrain ion drift.

FIG. 15 shows a cyclic ion guide incorporating a central PCB deflector 102 to provide guiding DC gradients. Pluralities of electrodes 101 are provided and at least partially surround the counter electrode arrangement 102.

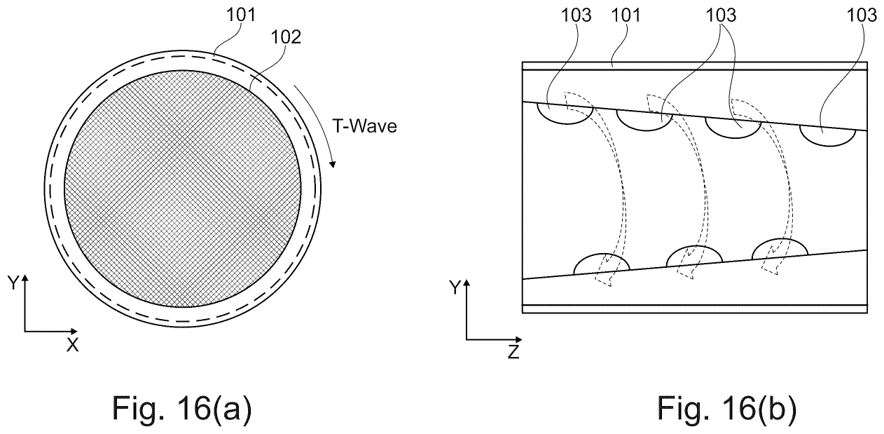

FIG. 16(a) shows an end cross section and FIG. 16(b) shows a side cross section of a circular equivalent to FIGS. 14(a), 14(b) and 14(c). A cylindrical deflector 102 is provided within a plurality of electrodes 101 arranged on a cylindrical surface. A spiral-shaped opening 103 in the deflector improves the guiding of ions in the manner described previously.

In these embodiments, complex three-dimensional ion paths may be provided. The counter electrode arrangement may be tapered, curved, conical or frustoconical. Additionally or alternatively, the plurality of electrodes is arranged may be cylindrical, conical, or frustoconical. These geometries can provide long path lengths. In such cases, the first plurality of electrodes and/or the second plurality of electrodes may at least partially enclose or fully enclose the counter electrode arrangement(s).

It will be understood that many variations may be made to the above systems and methods whilst retaining the advantages noted previously. For example, where specific components have been described, alternative components can be provided that provide the same or similar functionality.

Embodiments described herein include various potentials applied by the counter electrode arrangement as well as potentials the plurality of electrodes, or a plurality of electrodes on another surface. These various different potentials may combine (superimpose) to guide ions along the ion channels of the present disclosure.

The ion guides described herein can be incorporated into various mass spectrometry systems. The ion guides of the present disclosure may manipulate and control the movement of ions within a vacuum environment or within a pressurised gas (e.g., for ion mobility spectrometry). The ion guides may provide convenient devices for guiding ions from an ionisation source to a mass analyser, ensuring long ions paths, efficient ion transmission and/or accurate analysis.

The ion guides of the present disclosure may be operated within pressure-controlled or high-vacuum environments to reduce or minimise the likelihood of ion collisions with gas molecules. In such cases, the materials and construction of the ion guide to be compatible with vacuum conditions. For instance, gas-tight housings may be provided. In some embodiments, gases are introduced to assist in ion transport or cooling or to control the degree of ion separation in ion mobility experiments. The gas dynamics and pressure within the guide may be carefully controlled to control ion behaviour.

The ion guides of the present disclosure may provide precise control of voltage potentials within the devices to manipulate ion trajectories. In many embodiments, arrays of RF electrodes arranged on surfaces may be used to control the electric fields (and pseudopotentials) that guide ions along specific paths. The electrodes of the present disclosure may be connected to and/or incorporate various voltage sources. For examples, each electrode may be connected to one or more power supplies so as to apply a particular voltage potential, and the voltage applied to one or more of the electrodes (or each electrode) may be independently controllable. The electrodes of the ion guides described herein may be configured to have RF and/or DC fields applied thereto; the combination of these fields can create a complex potential landscape that provides complex ion motion.

The ion guides of the present disclosure can provide complex ion channels that extend between ion inlet and ion outlet ports. The ion inlets may connect to an ion source or another upstream ion processing component and the ion outlets may connect to a mass analyser or to some other downstream ion processing component.

Various different mass analysers can be used with the ion guides of the present disclosure. For example, the ion guides described herein can be used in conjunction with any one or more of: quadrupole analysers; time-of-flight analysers; ion traps; and/or orbital trapping mass analysers.

Methods are also provided. For example, in an aspect, there is provided a method of guiding ions along an ion channel of an ion guide that comprises a plurality of electrodes arranged on a surface and a counter electrode arrangement comprising a main counter electrode portion and an opening extending along the counter electrode arrangement, the method comprising: the plurality of electrodes applying a time-varying potential to repel ions from the surface; and the counter electrode arrangement applying a direct current, DC, counter potential to force the ions towards the surface, the time-varying potential and the DC counter potential together confining the ions in the ion guide; wherein the counter electrode arrangement applies a stronger DC counter potential in a region adjacent to the main counter electrode portion than in a region adjacent to the opening, thereby confining the ions in an ion channel corresponding to the opening.

Each feature disclosed in this specification, unless stated otherwise, may be replaced by alternative features serving the same, equivalent or similar purpose. Thus, unless stated otherwise, each feature disclosed is one example only of a generic series of equivalent or similar features.

As used herein, including in the claims, unless the context indicates otherwise, singular forms of the terms herein are to be construed as including the plural form and, where the context allows, vice versa. For instance, unless the context indicates otherwise, a singular reference herein including in the claims, such as “a” or “an” (such as an electrode or a potential) means “one or more” (for instance, one or more electrodes, or one or more potentials). Throughout the description and claims of this disclosure, the words “comprise”, “including”, “having” and “contain” and variations of the words, for example “comprising” and “comprises” or similar, mean that the described feature includes the additional features that follow, and are not intended to (and do not) exclude the presence of other components.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

Any steps described in this specification may be performed in any order or simultaneously unless stated or the context requires otherwise. Moreover, where a step is described as being performed after a step, this does not preclude intervening steps being performed.

All of the aspects and/or features disclosed in this specification may be combined in any combination, except combinations where at least some of such features and/or steps are mutually exclusive. In particular, the preferred features of the disclosure are applicable to all aspects and embodiments of the disclosure and may be used in any combination. Likewise, features described in non-essential combinations may be used separately (not in combination).

### Clauses

1. An ion guide for guiding ions along an ion channel, comprising:
   a plurality of electrodes arranged on a surface of the ion guide and configured to apply a time-varying potential to repel the ions from the surface; and
   a counter electrode arrangement comprising a main counter electrode portion and having an opening extending along the counter electrode arrangement, the counter electrode arrangement configured to apply a direct current, DC, counter potential to force the ions towards the surface, the time-varying potential and the DC counter potential together confining the ions in the ion guide;
   wherein the counter electrode arrangement is configured to apply a stronger DC counter potential in a region adjacent to the main counter electrode portion than in a region adjacent to the opening, thereby confining the ions in an ion channel corresponding to the opening.
2. The ion guide of clause 1, wherein the opening and the ion channel are circuitous.
3. The ion guide of clause 1 or clause 2, wherein the opening and the ion channel are circuitous in two spatial dimensions or in three spatial dimensions.
4. The ion guide of any preceding clause, wherein the opening and the ion channel each comprise one or more first portions that extend in a first direction and one or more second portions that extend in a second direction that is different to the first direction.
5. The ion guide of clause 4, wherein the opening and the ion channel comprise one or more third portions extending in a third direction that is different to the first and second directions.
6. The ion guide of clause 5, wherein:
   the second and third directions are substantially opposite directions; and/or
   an angle between the second and third directions is greater than 90 degrees or greater than 120 degrees.
7. The ion guide of any of clauses 4 to 6, wherein the first direction is substantially perpendicular to the second direction and/or the third direction.
8. The ion guide of any preceding clause, wherein the opening is an elongate opening in the counter electrode arrangement.
9. The ion guide of any preceding clause, wherein the counter electrode arrangement comprises a counter electrode and wherein the opening comprises a recess in the counter electrode.
10. The ion guide of clause 9, wherein a surface of the main counter electrode portion is at a first distance from the plurality of electrodes and a surface of the opening is at a second distance from the plurality of electrodes, the second distance being greater than the first distance.
11. The ion guide of any preceding clause, wherein the opening extends at least partially through the counter electrode arrangement.
12. The ion guide of any preceding clause, wherein the opening extends fully through the counter electrode arrangement.
13. The ion guide of clause 12, wherein the counter electrode arrangement comprises a backplate behind the opening, the backplate configured to apply a weaker DC counter potential to the ions than the main counter electrode portion.
14. The ion guide of any preceding clause, wherein the counter electrode arrangement comprises one or more main counter electrode portions adjacent to the opening and/or on each side of the opening.
15. The ion guide of any preceding clause, wherein the counter electrode arrangement is configured to apply a DC potential having a potential minimum corresponding to the opening and the ion channel.
16. The ion guide of any preceding clause, wherein the counter electrode arrangement is substantially parallel to the surface on which the plurality of electrodes is arranged.
17. The ion guide of any preceding clause, wherein:
the time-varying potential is a radiofrequency, RF, oscillatory potential.
18. The ion guide of any preceding claim, wherein each electrode of the plurality of electrodes is configured to apply a potential with a different phase to each adjacent electrode of the plurality of electrodes.
19. The ion guide of any preceding clause, wherein the plurality of electrodes comprises a set of electrodes configured to apply a travelling wave potential along one or more portions of the ion channel to guide the ions along the ion channel.
20. The ion guide of any preceding clause, wherein the plurality of electrodes comprises a set of electrodes configured to apply a DC potential gradient along one or more portions of the ion channel to guide the ions along the ion channel.
21. The ion guide of clause 20, when dependent on clause 19, wherein the sets of electrodes of the plurality of electrodes are configured to apply alternating travelling wave potentials and DC potential gradients along respective portions of the ion channel to guide the ions along the ion channel.
22. The ion guide of any preceding clause, wherein the plurality of electrodes is disposed along the length of the ion channel.
23. The ion guide of any preceding clause, wherein the electrodes of the plurality of electrodes are elongate electrodes arranged substantially perpendicular to the ion channel.
24. The ion guide of any preceding clause, wherein the counter electrode arrangement is inclined with respect to the surface on which the plurality of electrodes is arranged, preferably wherein the opening extends in a first direction and wherein the counter electrode arrangement is inclined in a direction that is different to the first direction, such that the counter potential guides the ions along at least a portion of the ion channel.
25. The ion guide of any preceding clause, wherein the counter electrode arrangement is configured to apply a travelling wave potential along one or more portions of the ion channel to guide the ions along the ion channel.
26. The ion guide of any preceding clause, wherein the ion channel is any one or more of: cyclic; helical; and/or circuitous in three dimensions.
27. The ion guide of any preceding clause, wherein the counter electrode arrangement at least partially encloses the plurality of electrodes.
28. The ion guide of clause 27, wherein the opening in the counter electrode arrangement extends along one or more internal surfaces of the counter electrode arrangement.
29. The ion guide of any preceding clause, wherein a cross section of the counter electrode arrangement is substantially parallelogram-shaped.
30. The ion guide of any preceding clause, wherein the counter electrode arrangement is tapered, curved, conical or frustoconical.
31. The ion guide of any preceding clause, wherein the surface on which the plurality of electrodes is arranged is cylindrical, conical, or frustoconical.
32. The ion guide of any preceding clause, wherein the main counter electrode portion is substantially planar and/or wherein the surface on which the plurality of electrodes is arranged is substantially planar.
33. The ion guide of any preceding clause, wherein the surface on which the plurality of electrodes is arranged is a first surface, the ion guide further comprises a second plurality of electrodes arranged on a second surface of the ion guide, and the second plurality of electrodes is configured to apply a second time-varying potential to repel the ions from the second surface.
34. The ion guide of clause 33, wherein the second plurality of electrodes is arranged on a rear surface of the surface on which the first plurality of electrodes is arranged.
35. The ion guide of clause 33 or clause 34, wherein the first surface and the second surface are substantially parallel and/or substantially planar.
36. The ion guide of any of clauses 33 to 35, wherein the second surface is inclined with respect to the first surface or substantially perpendicular to the first surface.
37. The ion guide of any of clauses 33 to 36, wherein the second plurality of electrodes is configured to apply a travelling wave potential(s) and/or a DC potential gradient potential(s) along one or more portions of the ion channel to guide the ions along the ion channel.
38. The ion guide of any of clauses 33 to 37, wherein the ion channel extends from the first plurality of electrodes to the second plurality of electrodes.
39. The ion guide of any of clauses 33 to 38, further comprising a second counter electrode arrangement opposing the second plurality of electrodes.
40. The ion guide of clause 39, wherein the opening extends along the first counter electrode arrangement and along the second counter electrode arrangement.
41. The ion guide of any of clauses 33 to 40, wherein the counter electrode arrangement at least partially encloses the first plurality of electrodes and/or the second plurality of electrodes.
42. The ion guide of any of clauses 33 to 40, wherein the first plurality of electrodes and/or the second plurality of electrodes at least partially encloses the counter electrode arrangement.
43. An ion mobility separator comprising the ion guide of any one the preceding clauses.
44. A mass spectrometry system comprising a mass analyser and the ion guide of any of clauses 1 to 42 or the ion mobility separator of clause 43.
45. An ion mobility spectrometer comprising the ion guide of any of clauses 1 to 42.
46. A method of guiding ions along an ion channel of an ion guide that comprises a plurality of electrodes arranged on a surface and a counter electrode arrangement comprising a main counter electrode portion and an opening extending along the counter electrode arrangement, the method comprising:
   the plurality of electrodes applying a time-varying potential to repel ions from the surface; and
   the counter electrode arrangement applying a direct current, DC, counter potential to force the ions towards the surface, the time-varying potential and the DC counter potential together confining the ions in the ion guide;
   wherein the counter electrode arrangement applies a stronger DC counter potential in a region adjacent to the main counter electrode portion than in a region adjacent to the opening, thereby confining the ions in an ion channel corresponding to the opening.

1. An ion guide for guiding ions along an ion channel, comprising:
a plurality of electrodes arranged on a surface of the ion guide and configured to apply a time-varying potential to repel the ions from the surface; and
a counter electrode arrangement comprising a main counter electrode portion and having an opening extending along the counter electrode arrangement, the counter electrode arrangement configured to apply a direct current (DC) counter potential to force the ions towards the surface, the time-varying potential and the DC counter potential together confining the ions in the ion guide,
wherein the counter electrode arrangement is configured to apply a stronger DC counter potential in a region adjacent to the main counter electrode portion than in a region adjacent to the opening, thereby confining the ions in an ion channel corresponding to the opening.

2. The ion guide of claim 1, wherein the opening and the ion channel are circuitous in at least two spatial dimensions.

3. The ion guide of claim 1, wherein the opening and the ion channel each comprise one or more first portions that extend in a first direction and one or more second portions that extend in a second direction that is different to the first direction.

4. The ion guide of claim 3, wherein the opening and the ion channel comprise one or more third portions extending in a third direction that is different to the first and second directions.

5. The ion guide of claim 4, wherein:
the second and third directions are substantially opposite directions; and/or
an angle between the second and third directions is greater than 90 degrees or greater than 120 degrees.

6. The ion guide of claim 4, wherein the first direction is substantially perpendicular to the second direction and/or the third direction.

7. The ion guide of claim 1, wherein the opening is an elongate opening in the counter electrode arrangement.

8. The ion guide of claim 1, wherein the counter electrode arrangement comprises a counter electrode and wherein the opening comprises a recess in the counter electrode.

9. The ion guide of claim 8, wherein a surface of the main counter electrode portion is at a first distance from the plurality of electrodes and a surface of the opening is at a second distance from the plurality of electrodes, the second distance being greater than the first distance.

10. The ion guide of claim 1, wherein the opening extends at least partially through the counter electrode arrangement.

11. The ion guide of claim 10, wherein the counter electrode arrangement comprises a backplate behind the opening, the backplate configured to apply a weaker DC counter potential to the ions than the main counter electrode portion.

12. The ion guide of claim 1, wherein the counter electrode arrangement comprises one or more main counter electrode portions adjacent to the opening and/or on each side of the opening.

13. The ion guide of claim 1, wherein the counter electrode arrangement is configured to apply a DC potential having a potential minimum corresponding to the opening and the ion channel.

14. The ion guide of claim 1, wherein the counter electrode arrangement is substantially parallel to the surface on which the plurality of electrodes is arranged.

15. The ion guide of claim 1, wherein:
the time-varying potential is a radiofrequency, RF, oscillatory potential; and/or
wherein each electrode of the plurality of electrodes is configured to apply a potential with a different phase to each adjacent electrode of the plurality of electrodes.

16. The ion guide of claim 1, wherein the plurality of electrodes comprises a set of electrodes configured to apply a travelling wave potential along one or more portions of the ion channel to guide the ions along the ion channel.

17. The ion guide of claim 1, wherein the plurality of electrodes comprises a set of electrodes configured to apply a DC potential gradient along one or more portions of the ion channel to guide the ions along the ion channel.

18. The ion guide of claim 16, wherein the plurality of electrodes further comprises a set of electrodes configured to apply a DC potential gradient along one or more portions of the ion channel to guide the ions along the ion channel, wherein the sets of electrodes of the plurality of electrodes are configured to apply alternating travelling wave potentials and DC potential gradients along respective portions of the ion channel to guide the ions along the ion channel.

19. The ion guide of claim 1, wherein the plurality of electrodes is disposed along the length of the ion channel.

20. The ion guide of claim 1, wherein the electrodes of the plurality of electrodes are elongate electrodes arranged substantially perpendicular to the ion channel.

21. The ion guide of claim 1, wherein the counter electrode arrangement is inclined with respect to the surface on which the plurality of electrodes is arranged, preferably wherein the opening extends in a first direction and wherein the counter electrode arrangement is inclined in a direction that is different to the first direction, such that the counter potential guides the ions along at least a portion of the ion channel.

22. The ion guide of claim 1, wherein the counter electrode arrangement is configured to apply a travelling wave potential along one or more portions of the ion channel to guide the ions along the ion channel.

23. An ion mobility separator comprising the ion guide of claim 1.

24. A mass spectrometry system comprising a mass analyser and the ion guide of claim 1.

25. An ion mobility spectrometer comprising the ion guide of claim 1.

26. A method of guiding ions along an ion channel of an ion guide that comprises a plurality of electrodes arranged on a surface and a counter electrode arrangement comprising a main counter electrode portion and an opening extending along the counter electrode arrangement, the method comprising:
the plurality of electrodes applying a time-varying potential to repel ions from the surface; and
the counter electrode arrangement applying a direct current (DC) counter potential to force the ions towards the surface, the time-varying potential and the DC counter potential together confining the ions in the ion guide,
wherein the counter electrode arrangement applies a stronger DC counter potential in a region adjacent to the main counter electrode portion than in a region adjacent to the opening, thereby confining the ions in an ion channel corresponding to the opening.
